(19) United States
(12) Patent Application Publication
(10) Pub. No.: US 2008/0063894 A1
(43) Pub. Date: Mar. 13, 2008

(54) ARTICLE WITH HIGH-HARDNESS CARBON COATING

(76) Inventors: Shoichi Nakashima, Hitachi (JP); Shinya Okamoto, Hitachi (JP); Noboru Baba, Hitachiota (JP); Shizuka Yamaguchi, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/832,676

(22) Filed: Aug. 2, 2007

(30) Foreign Application Priority Data
Sep. 12, 2006 (JP) 2006-246241

(51) Int. Cl. B32B 15/00

(52) U.S. Cl. 428/634

(57) ABSTRACT

An article comprising a substrate made of Al, Mg, Ti or an alloy whose main component is a member selected from the group consisting of aluminum, magnesium and titanium, an intermediate layer formed on the base having a thickness of 0.7 to 1.5 micrometers and containing aluminum and carbon, and a high-hardness carbon coating formed on the intermediate layer having a thickness of 1 to 2.5 micrometers, wherein a concentration of aluminum in the intermediate layer decreases along the direction from the substrate towards the high-hardness carbon coating, and a concentration of carbon in the intermediate layer increases along the direction from the substrate towards the high-hardness carbon coating;

### CLAIM OF PRIORITY

The present application claims priority from Japanese application serial No. 2006-246241, filed on Sep. 12, 2006, the content of which is hereby incorporated by reference into this application.

### FIELD OF THE INVENTION

The present invention relates to an article having a high-hardness carbon coating.

### BACKGROUND ART

In recent years, in order to lower friction loss of sliding members, forming of ceramics hard coatings such carbides as TiC or such metal nitrides as TiN on a substrate is widely employed.

Ceramic hard coatings are superior in abrasion resistance, but they have a friction coefficient of about 0.5 under no lubricant condition in an atmosphere. Thus, a lower friction coefficient has been required.

On the other hand, a self-lubricating sulfide compound coating such as molybdenum disulfide coating has been used, but it has a problem in life that the substrate is exposed by abrasion of the coating.

Recently, a high-hardness carbon coating has been in the spotlight. The high-hardness carbon coating is called DLC (Diamond Like Carbon) or amorphous carbon. The high-hardness carbon coating has a low friction resistance of graphite and high-hardness of diamond as well. It has such a low friction coefficient as about 0.1 in the atmosphere so that it has an excellent abrasion resistance.

On the other hand, since the high-hardness carbon coating is hard and brittle, it has problems in fitness or load resistance because it generates cracks or peel-off when it is applied on metallic substrates. Against these problems, an intermediate layer of silicon layer or chromium layer is generally formed between the high-hardness carbon coating and the metallic substrate, since Si and Cr are excellent for adhesion to both the metallic substrate and the high-hardness carbon coating.

An attempt has been made to obtain a higher adhesion, which is disclosed in patent document No. 1 and No. 2 wherein a multi-layered intermediate layer is disclosed.

Patent document No. 1: Japanese patent laid-open 2004-169137

Patent document No. 2: Japanese patent laid-open 10-203896

Since light metal alloys such as aluminum alloys (Al alloy), magnesium alloys (Mg alloy), titanium alloys (Ti alloy) are softer than steel materials, the high-hardness carbon coating (hereinafter referred to as carbon coating) may peel off by itself by stress concentration in an interface between the coating and the substrate when a thickness of the coating is large. Even if the coating is formed, the coating may be easily peeled off from the substrate by friction or scratching.

Though a method of forming an intermediate layer of Si or Cr as a stress relaxation layer has been known, which has an effect of preventing peeling-off in case of coatings of particular hardness or Young's modulus, durability of the coating comparable to anodized coating was not obtained.

Further, in case of substrates of light weight metals, a heat treatment temperature for increasing strength of the substrates is low; the substrates tend to be softened, due to an temperature rise during formation of the coating.

### SUMMARY OF THE INVENTION

Accordingly, the present invention aims at providing an article, especially sliding article with excellent adhesion and abrasion resistance, and with low friction as well.

The present invention provides an article comprising a substrate made of Al, Mg, Ti or an alloy whose main component is a member selected from the group consisting of aluminum, magnesium and titanium, an intermediate layer formed on the base having a thickness of 0.7 to 1.5 micrometers and containing aluminum and carbon, and a high-hardness carbon coating formed on the intermediate layer having a thickness of 1 to 2.5 micrometers, wherein a concentration of aluminum in the intermediate layer decreases along the direction from the substrate towards the high-hardness carbon coating, and a concentration of carbon in the intermediate layer increases along the direction from the substrate towards the high-hardness carbon coating;
wherein Al₄C₃ whose atomic ratio of aluminum to carbon is 4 to 3 is formed in a halved intermediate layer at the substrate side; and
wherein the high-hardness carbon coating contains 0.5 to 4.5 at % of aluminum.

### BRIEF DESCRIPTION OF THE DRAWINGS

FIG. 1 is a secondary electron image photograph of a cross section of a carbon coating of the present invention by a scanning electron microscope (SEM).

FIG. 2 is a perspective view of a test specimen.

FIG. 3 is a graph showing a relationship among Al concentration, hardness and Young's modulus of films.

FIG. 4 is a graph showing a relationship among an Al concentration (at %), electric powers for targets and time for forming films of the films of the present invention.

FIG. 5 is a graph showing a relationship among an Al concentration (at %), electric powers for targets and time for forming films of the films of comparative member 2.

FIG. 6 is a graph showing a relationship among an Al concentration (at %), electric powers for targets and time for forming films of the films of comparative member 4.

FIG. 7 is a graph showing a relationship among an Al concentration (at %), electric powers for targets and time for forming films of the films of comparative member 5.

FIG. 8 is a graph showing an Al concentration of a carbon coating of the present invention.

FIG. 9 is a perspective view of a piston to which the present invention is applied.

FIG. 10 is a diagrammatic perspective view of a reciprocal sliding mechanism of the present invention.

### EXPLANATION OF REFERENCE NUMERALS

1; substrate, 2; Si crystal, 3; intermediate layer, 4; surface layer, 5; interface, 6; piton, 7; treated surface, 8; guide mechanism, 9; guide rail, 10; pin, 11; treated surface.

### PREFERRED EMBODIMENTS FOR PRACTICING THE INVENTION

In one embodiment of the present invention, an article comprises a substrate of aluminum base alloy, magnesium base alloy, or titanium base alloy, an intermediate layer having a thickness of 1 to 2.5 micrometers and containing aluminum and carbon on the substrate, and a high-hardness carbon coating (diamond like carbon layer) having a thickness of 1 to 2.5 micrometers on the intermediate layer.

A concentration of aluminum in the intermediate layer decreases along the direction from the substrate towards the high-hardness carbon coating, but a concentration of carbon in the intermediate layer increases along the direction from the substrate towards the high-hardness carbon coating. At the same time, Al₄C₃ whose atomic ratio of aluminum to carbon is 4 to 3 is formed in a halved intermediate layer at the substrate side, and the high-hardness carbon coating contains 0.5 to 4.5 at %. In another embodiment of the present invention, an article comprises a substrate, an intermediate layer containing aluminum and carbon on the substrate, and a high-hardness carbon coating on the intermediate layer, wherein a concentration of aluminum in the intermediate layer decreases along the direction from the substrate towards the high-hardness carbon coating, a decreasing rate in the intermediate layer at the high-hardness carbon coating side being smaller than that in the substrate side.

The high-hardness carbon coating contains aluminum in 0.5 to 4.5 atomic %. A concentration of carbon in the intermediate layer increases along the direction from the substrate towards the high-hardness carbon coating in the intermediate layer at the high-hardness carbon coating side.

The substrate is preferably made of an aluminum base alloy containing copper of 1 to 2 at %, other aluminum base alloys, magnesium base alloys, titanium base alloys, aluminum, magnesium, or titanium. The high-hardness carbon coating should preferably be diamond like carbon.

A thickness of the high-hardness carbon coating should preferably be 1 to 2.5 micrometers. A thickness of the intermediate layer is 1 to 2.5 micrometers. In another embodiment of the article of the present invention, the intermediate layer on the substrate contains aluminum and carbon, and the high-hardness carbon coating on the intermediate layer, wherein Al₄C₃ formed in the intermediate layer is present in a halved area of the intermediate layer at the substrate side.

It is preferable to form an aluminum base alloy or aluminum layer in the interface between the substrate and the intermediate layer. The intermediate layer is preferably formed by a physical vapor deposition method. Properties of the high-hardness carbon coating (herein referred to as a coating) can be changed by adding hydrogen or metallic elements thereto. Aluminum was added to the coating, and a concentration of aluminum, hardness, Young's modulus, friction coefficient and abrasion amount were investigated in detail. As a result, properties of the coating change as a concentration of aluminum.

Based upon the results of the properties of the coating, an optimum intermediate layer was investigated. It has been revealed that when the concentration of aluminum is changed properly from the surface of the substrate towards the surface of the coating so as to relax the stress concentration, adhesion of the coating was improved.

The intermediate layer formed at the substrate side, for example, should have a composition that gives the intermediate layer substantially the same strength as that of the substrate, and should have a surface with a low friction and an interior with excellent abrasion resistance.

The intermediate layer formed between the coating and the substrate should be made of metallic material so as to harmonize the stress relaxation and deformability and should have a composition that gives the layer a strength close to that of the substrate.

Besides aluminum including unavoidable impurities, a composition of the intermediate layer made of a aging-hardened type light metal alloy such as duralumin is preferably prepared so that the intermediate layer has substantially the same mechanical properties such as hardness or Young's modulus.

A hardness of the intermediate layer can be controlled to 90 to 110% the hardness of the substrate. Similarly, Young's modulus can be controlled.

When an amount of carbon exceeds that of the atomic ratio of Al₄C₃, a strength of the intermediate layer increases as the carbon content increases.

On the other hand, a hardness of Al₄C₃ is close to that of aluminum; even when a content of aluminum increases towards the substrate, a little of strength changes. Therefore, if the thickness of the layer containing a relatively large amount of aluminum is large, adhesion strength lowers. A composition of the intermediate layer should be Al₄C₃ near the substrate.

In order to make a friction coefficient of the surface of the coating lower, it is necessary to prepare a composition of the surface of the coating that comes into contact with a counter member, the composition giving a low friction to the surface of the intermediate layer. In order to make the friction of the surface lower, a content of aluminum should be 0.5 to 4.5 at %.

According to application of the sliding members, an amount of aluminum is controlled so as to make the friction coefficient of the surface smaller, when a counter member is metallic material. In case where the counter member is an organic material, an amount of aluminum is controlled to obtain a desired friction coefficient.

In case where a combination of such members that affinity between the members appears after fine abrasion in the surfaces to become the friction coefficient stabile, an amount of aluminum is reduced to obtain a coating with an excellent abrasion resistance.

As has been described, it is possible to obtain coatings with high adhesion property in various light metal alloys such as Al alloy, Mg alloy or Ti alloy so that the sliding members can be light-weighted.

These light weight metal alloys are subjected to a final heat treatment at 120 to 200° C. The intermediate layer of the light metal alloys is formed by a physical vapor deposition method such as a sputtering method, an arc-ion plating method, etc to produce a low temperature coating.

As a sputtering source, at least two targets C and Al or Al alloy are used to control a composition according to positions of the intermediate layer. Target sources of a third and fourth additive element can be added if desired.

Especially, UBMS (Unbalanced Magnetron Sputter) method enables a temperature of the substrate 200° C. or lower at high speed of coating formation to produce a high density coating.

Because just addition of aluminum to the substrate increases adhesion of the carbon coating to the substrate, a chromium layer, which has been utilized to increase adhesion between the carbon layer and the substrate, which leads to reduction of the number of the targets for sputtering. Since the number of switching of the targets decreases, a process can be simplified and productivity increases and the process is economical.

According to the present invention, an article with excellent adhesion and withstand load particularly useful for sliding members is provided.

In the following, embodiments of the present invention will be explained by reference to drawings.

### Embodiment 1

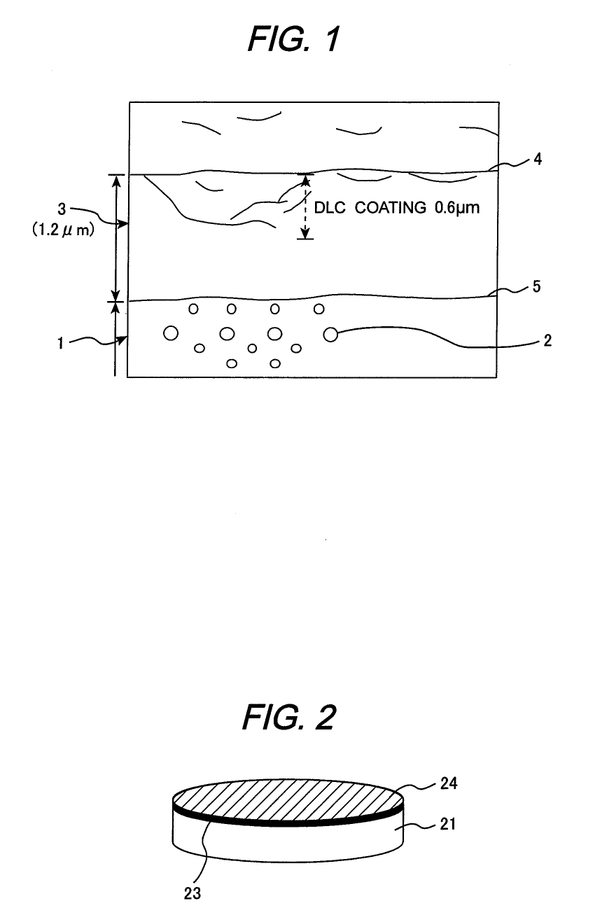

FIG. 1 is a photograph of secondary electron image of a sectional view of a sliding member according to the embodiment, the image being taken with a scanning electron microscope (SEM).

The substrate 1 is made of Al-11 wt % Si, wherein crystals 2 of Si having a diameter of 0.1 micrometer are dispersed in the substrate. An interface between the substrate 1 and an intermediate layer 3 including the DLC can be observed.

A thickness of the intermediate layer 3 is 1.2 micrometers. The interface between the intermediate layer 3 and the substrate 1 is made of 100% Al; a concentration of aluminum decreases continuously towards the surface 4 of the intermediate layer.

An inner layer structure of the intermediate layer could not be observed. A portion formed at the surface side 4 of the intermediate layer, which is considered as the intermediate layer 3 is a DLC layer of 0.6 micrometer thick to which Al is added.

Accordingly, there are the intermediate layer of 0.6 micrometer thick and the DCL layer of 0.6 micrometer thick. However, since there is a case where the interface between the intermediate layer of 0.6 micrometer and the DCL layer of 0.6 micrometer is not clear, the total of the 0.6 micrometer layer and the 0.6 micrometer DLC layer are called an intermediate layer 3 in this embodiment. In the following, described is a method for forming the intermediate layer and DLC layer together with compositions thereof.

As shown in FIG. 2, the intermediate layer 3 was formed by the unbalanced magnetron sputtering (UBMS) method where a intermediate layer 23 was formed on a surface 24 of the disc substrate 21. In the UBMS method, a balance among magnetic poles arranged at a rear side of a target is intentionally displaced between the center portion and the peripheral portion of the target, thereby to establish a non-equilibrium so that part of magnetic force lines from the peripheral portion of the target is extended until the substrate and plasma concentrated in the vicinity of the target is diffused until the vicinity of the substrate. As a result, in the process for forming the intermediate layer, an amount of ions irradiated to the substrate is increased thereby to form a dense layer.

In this embodiment, the targets for carbon and aluminum were operated respectively. The above apparatus was provided with the carbon target and the aluminum target; substrates made of three kinds of aluminum base alloys having compositions shown in Table 1, the substrates being mirror-polished, were put in such a way that surfaces the substrates to be treated are directed to the outer periphery of a cylindrical specimen holder in a vacuum chamber, and the chamber was evacuated. The specimen holder was turned around the center axis of the holder.

TABLE 1

| | Main additive elements (wt %) | | | |
|---|---|---|---|---|
| Substrate | Cu | Mn | Mg | Si |
| Al base | 3.8-5.0 | 0.3-1.0 | 0.2-1.8 | 0.5 or less |
| alloy 1 | | | | |
| Al base | 0.15-0.4 | 0.15 or less | 0.8-1.2 | 0.4-0.8 |
| alloy 2 | | | | |
| Al base | 2.0-5.0 | 0.5 or less | 0.6 or less | 4.0-12.0 |
| alloy 3 | | | | |

Ar was introduced into the chamber, and at the same time, a heating filament disposed in the chamber was supplied electric current and a bias voltage was applied intermittently to the substrate thereby to remove stains and thin oxide film were removed.

Thereafter, while methane gas was being introduced into the chamber, film forming was carried out, operating the Al target and the C target. Sputtering speeds of C and Al were controlled by an input power to the targets wherein concentrations of the intermediate from 100% of Al-0% C to 100% of C-0% Al were changed.

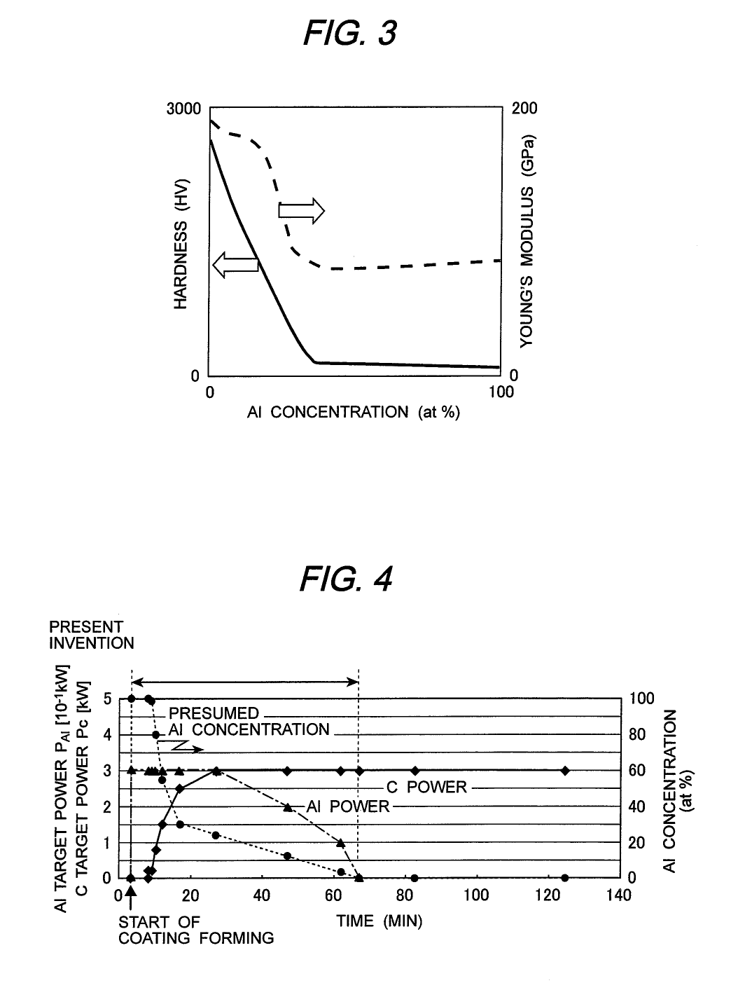

A bias voltage applied to the substrate during film forming was made constant to −100V, and the temperature was kept to about 200° C. At first, a carbon film with a constant Al concentration from the substrate side to the surface thereof and a thickness of 0.6 micrometer was prepared, and its hardness and Young's modulus were measured. Further, homogeneous films having different concentrations of Al were formed, a relationship between concentration of Al and hardness and Young's modulus of the films were shown in FIG. 3. The hardness and Young's modulus were measured by the nanoindentation method (ISO14577), and the hardness was converted into equivalent numbers to Vickers hardness.

The nanoindentation method was carried out by inserting Berkovich indenter with an angle of 115 degrees between opposite edges into the surface of the film for 10 seconds until the maximum load of 3 mN at which the maximum load was maintained for 1 second, followed by releasing the load in 10 seconds.

The hardness decreases as the concentration of Al increases; the hardness became almost constant over 35 at % or more of Al. Young's modulus decreases as the concentration of Al increases.

In case of a film of a concentration of Al being about 35 at %, Al₄C₃ formation was confirmed by measurement with an XPS (X-ray Photoelectron Spectroscopy). Under the above circumstances, a part of the intermediate layer 3 was formed until a thickness of 0.6 micrometer on a substrate of Al alloy, which was subjected to T6 treatment, the concentration of the film being continuously changed from Al 100%-0% C to 0%-100% C. Thereafter, DLC film of 0.6 micrometer thick was formed on the Al-C film thereby to produce a sliding member having the surface whose cross sectional structure is shown in FIG. 1.

The concentrations of Al and C were so controlled as the hardness of the films in the direction of film growth lineally increases. As shown in FIG. 4, the change of the concentration of Al became a graph being convex downwards, compared to the film whose concentration of Al decreases linearly from 100% to 0%; it is preferable to form at least three or more layers of different Al concentrations (a stepwise increase in the concentration) or a continuously changed Al concentration is preferable.

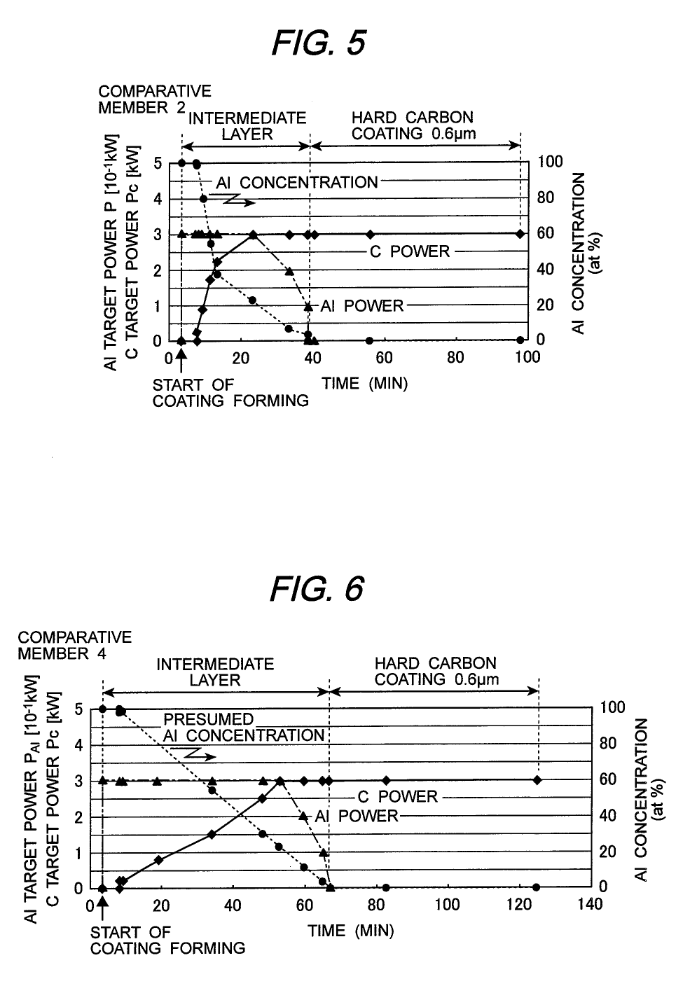

As a comparative member, an intermediate layer of Cr having 0.6 micrometer thick was formed on aluminum base alloy and a DLC layer having 0.6 micrometer thick was formed on the intermediate layer. Further, another comparative member 2 having an intermediate layer where the Al concentration changes continuously is shown in FIG. 5, wherein a concentration of Al changes in a graph being convex downwards.

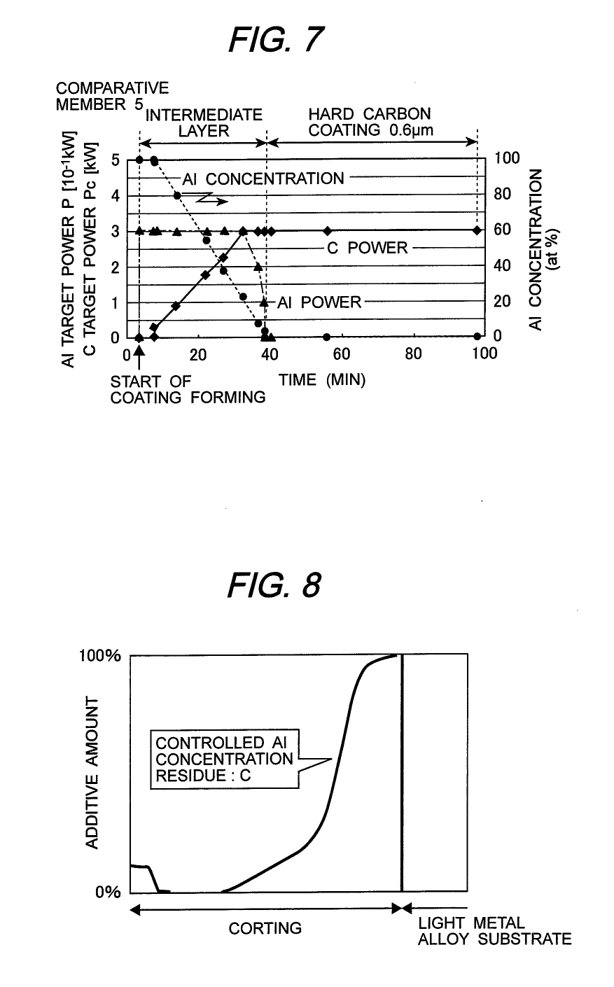

A comparative member 3, which has no intermediate layer but has only a DLC layer, was prepared. A comparative member 4 whose intermediate layer having an Al concentration changing linearly is 0.6 micrometer was prepared. A comparative member 5 is shown in FIG. 7 wherein the concentration is changed in proportion to the thickness. Withstand load properties in traces by a Rockwell C scale were compared.

A round trace was formed by the Rockwell C scale in each of the films, and cracks around the traces were observed. The results are shown in Table 2.

TABLE 2

| | Thickness of | Thickness of Al | | | |
|---|---|---|---|---|---|
| | Cr | added | Thickness of | | |
| | intermediate | intermediate | High-hardness | Result of | Result of |
| | layer | layer | Carbon layer | Rockwell | scratch test |
| Material | (μm) | (μm) | (μm) | C scale | (%) |
| Comparative | Cr (0.6) | 0.6 | 0.6 | Radial | 100 |
| member 1 | | | | cracks | |
| Present | No | 0.6 | 0.6 | No | 171 |
| invention | | | | breakage | |
| Comparative | no | 0.3 | 0.6 | Fine | 118 |
| member 2 | | | | cracks | |
| | | | | around the | |
| | | | | trace | |
| Comparative | No | No | 0.6 | Fine | 52 |
| member 3 | | | | peeling | |
| | | | | off | |
| Comparative | No | 0.6 | 0.6 | Radial | 105 |
| member 4 | | | | cracks | |
| Comparative | No | 0.3 | 0.6 | Fine | 86 |
| member 5 | | | | cracks | |
| | | | | around the | |
| | | | | trace | |

In case of the comparative member 1, many radial cracks were generated around the trace. In case of the comparative member 2, circular cracks that surround the trace were formed. In case of the comparative member 3, peeling off of the film was observed so that the substrate around the trace was exposed. In case of the comparative member 4, many radial cracks were formed around the trace. In case of the comparative member 5, circular cracks that surround the trace were formed.

In case of the carbon coating of the present invention, cracks or peeling off were not recognized. A scratch test for evaluating durability of the carbon coating at the time of sliding was conducted.

The scratch test was conducted in the following manner. A diamond indenter worked into a ball having a radius of 200 micrometers was brought into contact with the carbon coating in a perpendicular direction to the surface thereof. A load was gradually increased and the diamond ball was moved in a direction parallel to the surface of the carbon coating to form a scratch. Observation of the scratch makes it possible evaluate durability and peeling off of the carbon coating. A distance of parallel movement was 10 mm.

A load at which a surface of the substrate in the bottom of the scratch was exposed was defined as a critical load. As the standard specimen, the comparative member 1 was used to evaluate the durability.

Compared to the critical load of the comparative member 1, the comparative member 2 exhibited 118%, the comparative member 3 exhibited 52%, the comparative member 4 exhibited 105%, and the comparative member 5 exhibited 86%. The comparative member 2 exhibited a relatively good result.

In case of the carbon coating of the present invention, the critical load was 171%; it has been revealed that the carbon coating of the present invention has excellent withstand load property and anti-peeling off property, in view of both the Rockwell C scale and the scratch test.

When a hardness increases linearly from the substrate, it was confirmed that the thickness of the intermediate layer needed at least 0.5 μm.

If the composition of the intermediate layer is changed linearly in proportion to time, the change of the composition of Al tends to become convex upwards; since a brittle layer formal to Al₄C₃ becomes thick thereby to make the durability and anti-peeling off worse.

Accordingly, the present invention provide a high-hardness carbon coating with excellent anti-abrasion property, withstanding load property and high adhesion. According to the present embodiment, since the occurrence of cracks can be suppressed, the anti-corrosion of the substrate is improved by shut-off from the environment. Optimization of the concentration of Al and concentration change in accordance with strength properties of the carbon coating can improve withstanding load property and adhesion property.

When only argon gas was introduced into the chamber without introduced methane gas, a film obtained exhibited the same results. Further, friction coefficients of the different homogeneously Al added carbon coating layers were measured; when 0.5 to 4.5 at % of Al is added, the high-hardness carbon coating exhibited a friction coefficient of the carbon coating was as small as 0.1 or less. Accordingly, in order to reduce a loss of light-weight sliding members, it is effective to control the Al concentration of the surface portion of the carbon coating.

On the other hand, since a high-hardness carbon coating to which 0.5 to 4.5 at % of Al is added decreases its hardness, an additive amount of Al to satisfy adhesion to the substrate and hardness of the interior, i.e. both anti-abrasion property and low friction property. A C target and Al target were set in the UBMS apparatus; in addition to the above procedure of producing the specimens shown in FIG. 2, Al was deposited on the surface 24 of the specimen.

An intermediate layer was formed on am aluminum base alloy A2024, which was subjected to T6 heat treatment, wherein the formation of the layer continued until it had a thickness of 0.6 micrometer and Al—C concentrations were continuously changed from 100 at % and 0% to 0 at % and 100 at %, respectively.

Thereafter, a first high hardness carbon coating (DLC) having a thickness of 0.4 micrometer was formed; again, another DLC layer having a thickness of 0.2 micrometer and an Al concentration of 2 at % was formed by operating the Al target on the first carbon coating.

A friction coefficient of the resulting article that was measured in an unlubricated condition was 0.05. If the low friction coefficient is desired for a long period of time, it is desirable to control the minimum concentration of Al in the carbon coating to 0.5 to 4.5 at %.

A hardness in the vicinity of the interface between the coating and the substrate in this embodiment was investigated in detail; as a result, it was revealed that the carbon coating was softer than the substrate. It is possible to improve adhesion to the substrate by increasing a strength of the coating at the substrate side.

In forming the coating at the substrate side by sputtering, it is effective to add and alloy elements selected from main components of the substrate alloy or additive elements to the substrate alloy, which increase strength of aluminum.

In this embodiment, Cu, which is a secondary element of A2024 was used. A C target, Al target and Cu target were put in the UBMS apparatus and the above-mentioned sputtering process whose part was modified was conducted wherein immediately after Al sputtering started, the Cu target was operated to thereby add Cu of 4 wt % of the Al concentration.

An atomic ratio of Al to Cu was kept constant at 1.5; concentrations of Al, Cu and C were changed continuously from a total concentration of Al and Cu being 100% and C being 0% to a total concentration of Al and Cu being 0% and C being 100%. Then, a high-hardness carbon coating (DLC) was grown until 0.6 micrometer thick to obtain an article whose sectional view is shown in FIG. 1.

Concentrations of Al and C were controlled to give hardness which is increases linearly in a growing direction of the coating. When a trace was formed with a Rockwell C scale on the resulting specimen, no cracks were observed. A scratch test result showed an increased adhesion; i.e. a critical load of about 190% that of the comparative member 1 having a Cr intermediate layer.

Using the UBMS apparatus, formation of coating by sputtering of an A2024 alloy target was conducted. There was an adhesion improvement similar to that of a method wherein the Al target and Cu target were cooperatively controlled.

An Al alloy target whose composition is similar to A6061, which has similar strength to the substrate such as A6061, can be used instead of the Al target thereby to improve adhesion property.

FIG. 2 shows a specimen of a substrate 1 having a diameter of 21.5 mm, and a thickness of 5.2 mm, a high-hardness carbon coating being formed on one face of the specimen. An adhesion, hardness and Young's modulus of the specimen were evaluated. The test was carried out under a bias voltage of 100 V. It was possible to provide a carbon coating and article with excellent load withstanding, anti-abrasion and adhesion.

### Embodiment 2

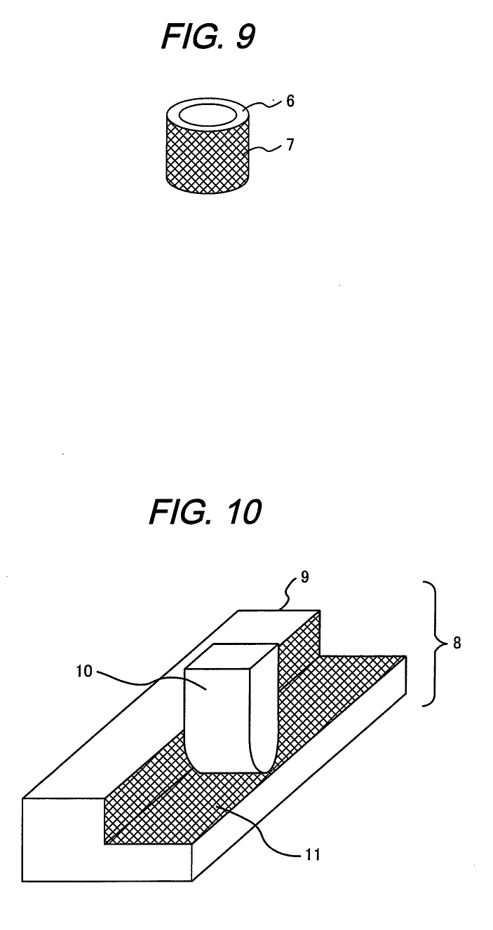

FIG. 9 shows a perspective view of a working piston for transfer liquid to which the carbon coating of the present invention was applied. As the working piston for transfer liquid, which is inserted into a cylinder made of cast steel, for example, and is subjected to repeated friction with the cylinder, pistons made of iron materials have been used. Although light weight pistons are preferable for improving working responsibility, use conditions of light weight pistons made of light metals have been limited because of their poor anti-abrasion. When the piston 6 is made of aluminum alloy and the periphery of the piston is coated with the high-hardness carbon coating, abrasion of the piston was ½ of the iron piston under the conditions for practical use and the working responsibility was improved because of lightweight.

A sliding member according to the present invention was used as a guide mechanism 8 for positioning shown in FIG. 10. A guide rail 9 that contacts with the pin 10 for making reciprocal linear movement was made of magnesium alloy and a surface of the pin 10 that contacts with the guide rail was made of the high-hardness carbon coating. As a result, the life of the guide rail could be expanded by about 10 times that of a non-treating member with a carbon coating.

When the pistons, guide rails or counter members are made of the light weight sliding members of the present invention, it is possible to make light weight and anti-abrasion, high reliability of the members. Further, low friction of the members can be realized. The members of the present invention can be applied to parts that are used under similar friction states; for example, in case of cam mechanisms, rolling bearings, gears, etc, light weight and anti-abrasion can be increased and low friction loss can be realized.

The present invention is particularly applied to members used under sliding conditions.

What is claimed is:

1. An article comprising a substrate made of Al, Mg, Ti or an alloy whose main component is a member selected from the group consisting of aluminum, magnesium and titanium, an intermediate layer formed on the base having a thickness of 0.7 to 1.5 micrometers and containing aluminum and carbon, and a high-hardness carbon coating formed on the intermediate layer having a thickness of 1 to 2.5 micrometers, wherein a concentration of aluminum in the intermediate layer decreases along the direction from the substrate towards the high-hardness carbon coating, and a concentration of carbon in the intermediate layer increases along the direction from the substrate towards the high-hardness carbon coating; wherein Al₄C₃ whose atomic ratio of aluminum to carbon is 4 to 3 is formed in a halved intermediate layer at the substrate side; and
wherein the high-hardness carbon coating contains 0.5 to 4.5 at % of aluminum.

2. An article comprising a substrate, an intermediate layer containing aluminum and carbon and a high-hardness carbon coating, wherein a concentration of aluminum in the intermediate layer decreases along the direction from the substrate towards the high-hardness carbon coating, a decreasing rate of aluminum in an area close to the high-hardness carbon coating being smaller than that in an area close to the substrate.

3. The article according to claim 2, wherein the high-hardness carbon coating contains 0.5 to 4.5 at %.

4. The article according to claim 2, wherein a concentration of carbon in the intermediate layer increases along the direction from the substrate towards the high-hardness carbon coating, an increasing rate of carbon being smaller than that in an area close to the substrate.

5. The article according to claim 2, wherein the substrate is an aluminum alloy containing copper in an amount of 1 to 2 at %.

6. The article according to claim 2, wherein the substrate is a member selected from the group consisting of aluminum base alloy, magnesium base alloy, titanium base alloy, aluminum, magnesium and titanium.

7. The article according to claim 2, wherein the high-hardness carbon coating is of diamond-like carbon.

8. The article according to claim 2, wherein the high-hardness carbon coating has a thickness of 1 to 2.5 micrometers.

9. The article according to claim 2, wherein the intermediate layer has a thickness of 0.7 to 1.5 micrometers.

10. An article comprising a substrate, an intermediate layer containing aluminum and carbon, and a high-hardness carbon coating, wherein Al₄C₃ formed in the intermediate layer is present in a halved intermediate layer at the substrate side.

11. The article according to claim 2, wherein an aluminum layer or an aluminum base alloy layer free from carbon is formed in an interface of the substrate and the intermediate layer.

12. The article according to claim 2, wherein the intermediate layer is formed by physical vapor deposition.
